(19) United States
(12) Patent Application Publication
(10) Pub. No.: US 2010/0234008 A1
(43) Pub. Date: Sep. 16, 2010

(54) OPERATING SYSTEM UPDATES FOR MOBILE DEVICES VIA TEXT MESSAGES

(75) Inventor: Saurav Kumar, Bangalore (IN)

Correspondence Address: TUROCY & WATSON, LLP, 127 Public Square, 57th Floor, Key Tower, CLEVELAND, OH, 44114, US

(73) Assignee: SYMBOL TECHNOLOGIES, INC., Holtsville, NY (US)

(21) Appl. No.: 12/400,870

(22) Filed: Mar. 10, 2009

(51) Int. Cl. H04M 3/00; H04W 4/12; H04B 7/00; H04W 84/02

(52) U.S. Cl. 455/419; 455/466; 455/41.2; 370/338

(57) ABSTRACT

A system and/or methodology for upgrading mobile devices via text messages. The user of a source mobile device can send a text message, having a special identifier, to a set of destination mobile devices to be updated. The text message can include a file transfer protocol-server internet protocol address and a file name with a file path. The destination device obtains the text message, processes it, and sends a request to the file transfer protocol-server internet protocol address for the specified update file. The ftp server responds to the request with a data packet containing the update file, which the destination device installs.

### BACKGROUND

Wireless communication technology has experienced significant growth over the past several years. This growth has lead to wireless systems with increased sophistication, computing power, and storage capability. A single mobile device can be employed to effect numerous types of functionality as well as provide multiple applications. Many mobile devices, such as portable cellular phones, act as communication devices, word processing devices, and media players. In addition, many mobile devices are employed in commercial and industrial applications to provide a wide array of services and functionality.

In order to facilitate control and functionality of the mobile devices very advanced operating systems have been developed. Yet, with the rapid deployment of newer and more powerful applications it often necessary to update the operating systems on mobile devices. Typically, updates of a commercial/industrial mobile device's operating system are accomplished through SD card, local area network, network management system, etc. However, these methods can be difficult to implement for mobile devices in remote locations.

Along with the increase in wireless communication technology there has also been a paradigm shift in the way that people communicate via mobile devices. As a consequence, typical modern mobile devices can have several mechanisms by which data can be generated, sent, and received. Therefore, it would be desirable to have an efficient and easy to operate system for updating the operating system, firmware, and so forth for mobile devices.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more aspects of the subject innovation, various aspects are described in connection with operating system updates for mobile devices via text messages. According to related aspects, a mobile device capable of updating its operating system via text message is provided. The mobile device includes an inbox that collects text messages from at least one mobile device, and an agent that detects an identifier on at least one text message in the inbox, wherein the identifier designates the text message as a configuration file, and the agent processes the configuration file text message.

Another aspect relates to a method for facilitating mobile device updates. The method includes the steps of receiving at least one text message having an indicator, wherein the indicator identifies the text message as containing a configuration file, and processing the configuration file contained in the text message, including determining at least one of a server internet protocol address, a file name, or a file path from the configuration file.

Yet another aspect relates to a system for mobile device updates. The system can include means for receiving at least one text message having an identifier, wherein the identifier indicates that the text message contains a configuration file, means for processing the configuration file contained in the text message, including determining a server internet protocol address, a file name, and a file path from the configuration file, means for transmitting a request to the server internet protocol address contained in the configuration file, means for receiving a data packet from the server in response to the request, wherein the data packet is the file specified in the configuration file, and means for updating the mobile device by installing the file contained in the data packet.

Still another aspect relates to a system for updating mobile devices, including a first mobile device that transmits a text message to at least one additional mobile device, wherein the text message includes an identifier that indicates the text message includes a configuration file, a second mobile device that receives the text message, detects the identifier, processes the configuration file, and determines a server internet protocol address, a file name, and file path based on data contained in the configuration file, and sends a request to the internet protocol address for the file having the specified file name and path, and a server residing at the internet protocol address that transmits a data packet to the second mobile device in response to the request, wherein the data packet includes at least one of a operating system or firmware update.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates an example multiple access wireless communication system in accordance with an aspect of the subject specification.

FIG. 2 illustrates a general block diagram of a communication system in accordance with an aspect of the subject specification.

FIG. 3 illustrates an example communication system in accordance with an aspect of the subject specification.

FIG. 4 illustrates an example system that facilitates software updates for mobile devices via text messages in accordance with an aspect of the subject specification.

FIG. 5 illustrates an example wireless communication system that enables software updating for mobile devices via text messages in accordance with an aspect of the subject specification.

FIG. 6 illustrates an example text message in accordance with an aspect of the subject specification.

FIG. 7 illustrates an example methodology for updating mobile devices via text messages in accordance with an aspect of the subject specification.

FIG. 8 illustrates an example of a handheld terminal operative to execute the systems and/or methods disclosed herein.

FIG. 9 illustrates an exemplary device operative to execute the one or more embodiments disclosed herein.

FIG. 10 is a schematic block diagram illustrating a suitable operating environment in accordance with an aspect of the subject disclosure.

### DETAILED DESCRIPTION

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used.

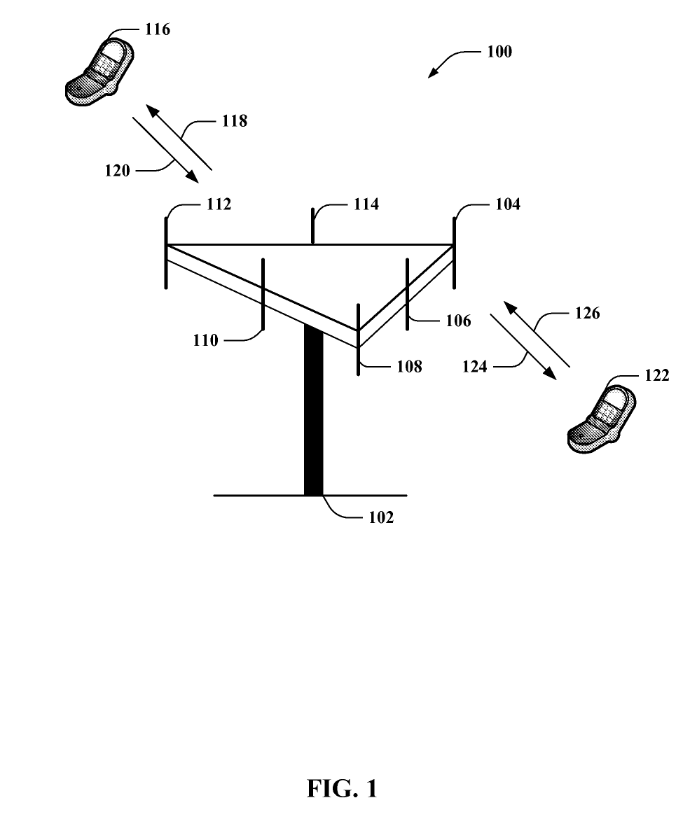

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beam-forming to improve signal-to-noise ratio of forward links 118 and 124 for mobile devices 116 and 122. This can be provided by using a precoder to steer signals in desired directions, for example. Also, while base station 102 utilizes beam-forming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology in one example.

According to an example, system 100 can be a multiple-input multiple-output (MIMO) communication system. Further, system 100 can utilize substantially any type of duplexing technique to divide communication channels (e.g., forward link, reverse link, etc.) such as FDD, TDD, and the like. Moreover, the system 100 can be a multiple-bearer system. A bearer can be an information path of defined capacity, delay, bit error rate, etc. Mobile devices 116 and 122 can each serve one or more radio bearers. The mobile devices 116 and 122 can employ uplink rate control mechanisms to manage and/or share uplink resources across the one or more radio bearers. In one example, the mobile devices 116 and 122 can utilize token bucket mechanisms to serve the radio bearers and to enforce uplink rate limitations.

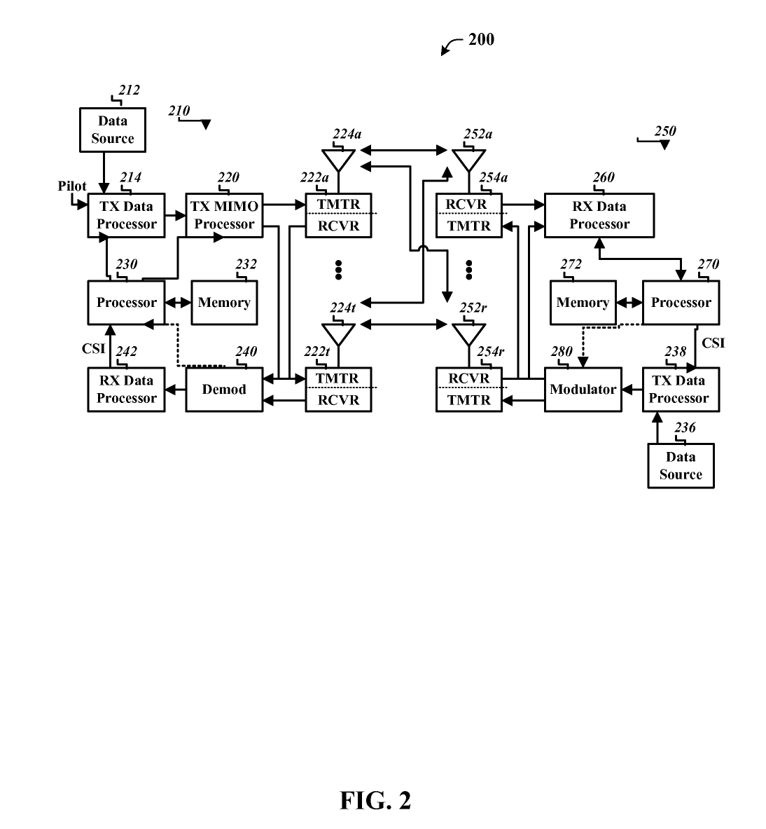

FIG. 2 is a block diagram of a transmitter system 210 (also known as the access point) and a receiver system 250 (also known as access terminal) in a MIMO system 200. At the transmitter system 210, traffic data for a number of data streams is provided from a data source 212 to a transmitter (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beam-forming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

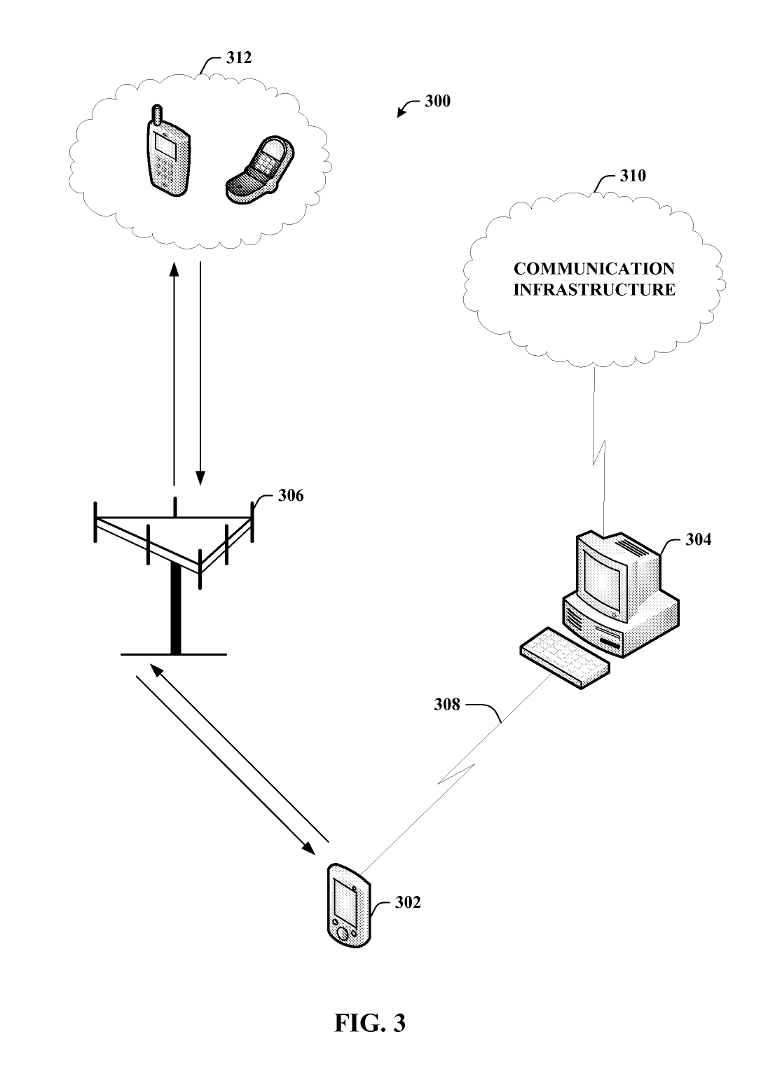

Turning to FIG. 3, an example communication system is shown in accordance with an aspect of the current innovation. The communication system 300 includes a mobile device 302, a file transfer protocol (ftp) server 304, and an access point 306. The wireless communication system 300 enables the mobile device 302 to alter, modify, or otherwise update software executing on the mobile device 302, such as an operating system, firmware, etc. The mobile device 302 can include cell phones, smart phones, laptops, handheld communication devices, scanners, handheld computing devices, satellite radios, global positioning systems, PDAs, and so forth.

The mobile device 302 can transmit and/or obtain data (e.g., request, files, etc.) from the ftp server 304 via a communication link 308. The communication link 308 can include a general packet radio service (GPRS), a Wi-Fi connection, Bluetooth, CDMA, Wired LAN, 3G, AdHoc Network, 4G, or most any suitable wired or wireless communication protocol. The ftp server 304 can include a desktop computer, a laptop computer, a mobile device, a web server, a mainframe, and so forth. More generally, the ftp server 304 can include most any computing system capable of obtaining data from a global communication framework (e.g., such as the Internet), or a computer readable medium, and transferring the data to one or more mobile devices via a wired or wireless communication network. As illustrated, the ftp server 304 can obtain and send data to a communication infrastructure 310 (e.g., Internet, an Intra-net, etc.). For example, the ftp server 304 can retrieve data, such as a mobile device software update, via the communication infrastructure, and store it in a data store (not shown). In addition, the mobile device 302 can download the data from the ftp server 304 via the communication link 308.

As discussed previously, the access point 306 (e.g., base station) enables the mobile device 302 to communicate with a plurality of additional mobile devices via a wireless communication network 312. For example, the mobile device 302 can exchange data (e.g., voice, text message, etc.) with most any mobile device associated with the wireless communication network 312 via the access point 306. It is to be appreciated that this example is illustrated for brevity and ease of explanation, and those skilled in the art will be able to readily identify additional or alternative embodiments within the scope and spirit of the subject innovation.

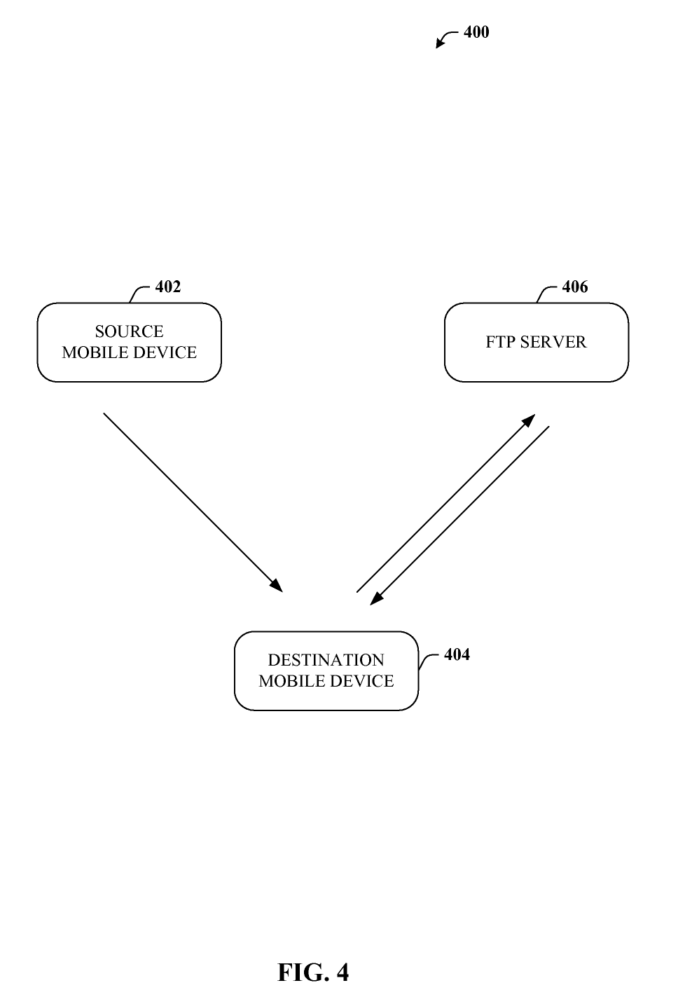

FIG. 4 illustrates an example system that facilitates software updates for mobile devices via text messages in accordance with an aspect of the current innovation. The system 400 includes a source mobile device 402, a destination mobile device 404, and a file transfer protocol (ftp) server 406. As discussed previously, the source mobile device 402 and the destination mobile device 404 can exchange data, such as voice data, text messages (e.g., sms), and so forth, via a wireless communication network. For instance, the source mobile device 402 (e.g., GSM or CDMA device) can transmit a text message to the destination mobile device 404. The text message consists of an ftp server IP address, ftp server user name and password (if necessary), a file name, and a file path in addition to an indicator that designates the text message as a configuration file.

The destination mobile device 404 can identify the text message received from the source mobile device 402 as containing a configuration file, and extract the ftp server IP address, and file name/path. The destination mobile device 404 can establish communication with the ftp server 406 (assuming that the ftp server 406 is the ftp server at the server IP address), and send a request for the file having the specified file name at the specified path. For example, the source mobile device 402 can send the destination mobile device 404 a text message having an identifier, a ftp address corresponding to the ftp server 406, and a file name and path to be downloaded. The destination mobile device 404 can determine that the text message contains a configuration file based on the indicator, and extract the contents, namely the ftp address and file name/path. In addition, the destination mobile device can send a request to the ftp server 406 for the file indicated in the text message.

The ftp server 406 can receive the request from the destination mobile device 404, and if the subject file is available at the specified address, then the destination mobile device 404 can download the file. The destination mobile device 404 can execute the file to upgrade, update, or otherwise modify its software, including but not limited to an operating system, firmware, and so forth. It is to be appreciated that the foregoing is but one example, and a plurality of embodiments are possible within the scope and spirit of the subject innovation.

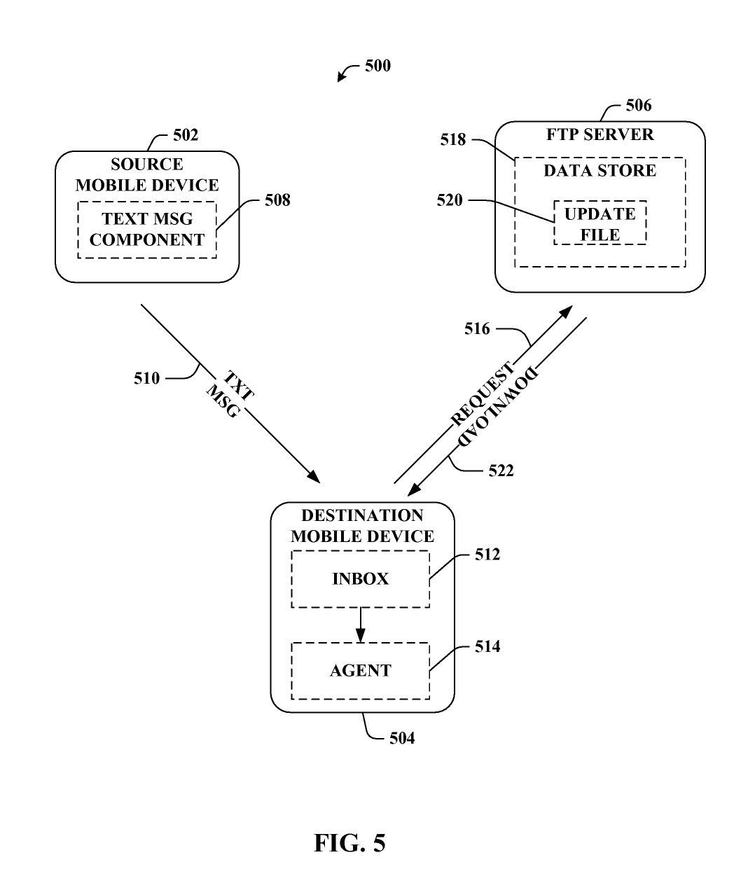

Referring to FIG. 5, an example wireless communication system that enables software updates for mobile devices via text messages is shown in accordance with an embodiment of the subject innovation. The system 500 includes a source mobile device 502 (source mobile), a destination mobile device 504 (destination mobile), and an ftp server 506. As discussed previously, the mobile devices 502 and 504 can include but are not limited to cell phones, smart phones, laptops, handheld communication devices, scanners, handheld computing devices, satellite radios, global positioning systems, PDAs, and so forth. In addition, the ftp server 304 can include a desktop computer, a laptop computer, a mobile device, a server, a mainframe, etc.

The source mobile 502 includes a text message component 508 (e.g., text msg, txt msg, etc.) that can transmit text messages (e.g., sms, etc.) to one or more target mobile devices via a wireless communication infrastructure (discussed supra). For example, the text message component 508 can transmit a text message to N recipients, where N is an integer. Moreover, the text message component 508 can send, broadcast, or otherwise transmit a text message 510 that consist of a configuration file to the destination mobile 504. For example, the text message 510 can include an indicator that designates the text message as a configuration file including but not limited to a ftp server IP address, and a file name/path.

The text message 510 can be obtained, acquired or otherwise received by the destination mobile 504, and placed into an inbox 512. The inbox 512 stores incoming or received text messages regardless of their contents. An agent 514 can query the inbox 512 and determine that the text message 510 contains a configuration file based on the indicator contained in the text message 510. Additionally or alternatively, the inbox 512 can determine that the text message 510 contains a configuration and notify the agent 514. The agent 514 can be a small application, process, thread, etc. that executes on the destination mobile 504, and processes text messages containing a configuration file (e.g., txt message 510). The agent 514 can search for a text message containing a configuration file continuously or periodically (e.g., daily, weekly, hourly, etc.). The agent 514 sends a request 516 to the ftp server 506 at the address specified in the text message 510.

The ftp server 506 includes a data store 518 capable of storing a plurality of file types. The data store 518 can contain an update file 520 at the location (e.g., file path) specified by the text message 510. The ftp server 506 processes the request 516, and if the update file 520 (e.g., OSUPDATE.apf) is present in the data store 518, then the destination mobile device can download 522 the update file 520 via a wireless communication system (e.g., Wi-Fi, GPRS, Bluetooth, CDMA, Wired LAN, WWAN, 3G, AdHoc Network, 4G, etc.). The destination mobile 504 can execute the update file 520, wherein the update file 520 updates the destination mobile's 504 operating system or firmware.

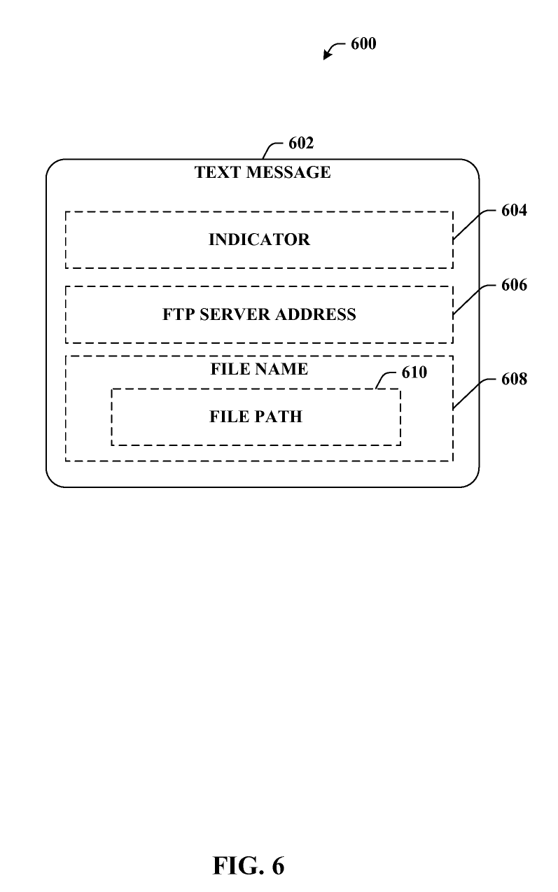

FIG. 6 an example text message is shown in accordance with an aspect of the subject innovation. The text message 602 includes an indicator 604, a ftp server address 606, and a file name 608. The indicator 604 notifies one or more recipients that the text message 602 is, or contains, a configuration file. As discussed previously, the receiving mobile device (not shown) can include an agent that continuously or periodically queries the text messages for the indicator 604, and processes the text messages 602.

In addition, the text message 602 includes an ftp server address 606. The ftp server address 606 notifies the receiving mobile device of which ftp server it should request the file(s) contained in the text message from. The file name 608 indicates which file the receiving mobile device is to request, and can contain a file path 610 that designates where on the ftp server the file can be found. For example, the text message 602 can have 192.168.1.1 as the ftp server address 606, and OSUPDATE.apf can be the file name. In which case, the mobile device(s) receiving the text message 602 would send a request to the ftp server located at 192.168.1.1 for the file OSUPDATE.apf. As discussed previously, the mobile device can download the file from the ftp server located at 192.168.1.1 via a wireless network (e.g., Wi-Fi, GPRS, CDMA, Bluetooth, WLAN, 3G, AdHoc Network, 4G, etc.), and the mobile device can execute OSUPDATE.apf to update its operating system, firmware, etc.

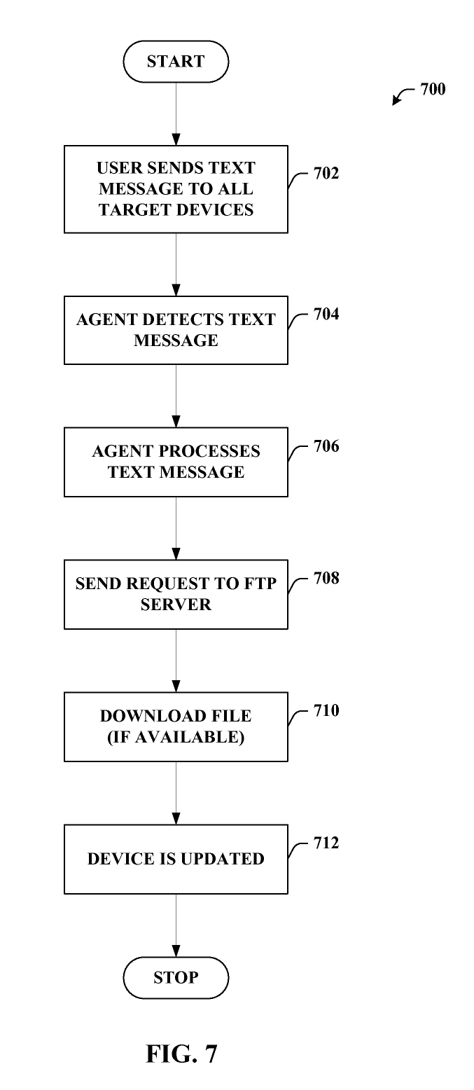

In view of the exemplary systems described supra, a methodology that may be implemented in accordance with the disclosed subject matter will be better appreciated with reference to the flow chart of FIG. 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, the illustrated blocks do not represent all possible steps, and not all illustrated blocks may be required to implement the methodologies described hereinafter.

Referring now to FIG. 7, an example methodology for updating mobile devices via text message is shown in accordance with an aspect of the subject innovation. At 702, a user sends a text message to all target devices. As discussed previously, the text message can contain an identifier that designates the text message as a configuration file to the receiving mobile devices. In addition, the set of target devices includes mobile devices for which the user desires to update one or more software components. For example, the user can be a network administrator for a commercial enterprise that has N mobile devices, where N is an integer. The network administrator can determine that it is time to update the operating system on the mobile devices, and can send a text message containing a configuration file (discussed supra) to all N mobile devices, or a subset of the N devices.

At 704, an agent executing on the receiving mobile device can detect the text message containing the configuration file (e.g., configuration file text message) based on the identifier. For example, the identifier can be header contained in the text message that identifies the text message as containing a configuration file. The agent can continuously or periodically look for text messages having the identifier. At 706, the agent processes the configuration file text message. For instance, the configuration file text message can contain an FTP server IP address, and a file name including the file path (e.g., desired file). At 708, the agent sends one or more request to the FTP server specified in the configuration file text message for the desired file. For instance, if the configuration file text message specifies that the desired file is OSUPDATE.apf from a FTP server located at X, then the agent sends a request to X for the file OSUPDATE.apf.

At 710, if the desired file is present at the FTP server, then the mobile device can download the file. For instance, if the desired file (e.g., OSUPDATE.apf) is at the specified file path on the FTP server located at X, then the mobile device can download the file. At 712, the target mobile device can run, implement or otherwise execute the requested file. For instance, the requested file can be an update for the mobile device's operating system, firmware, and so forth.

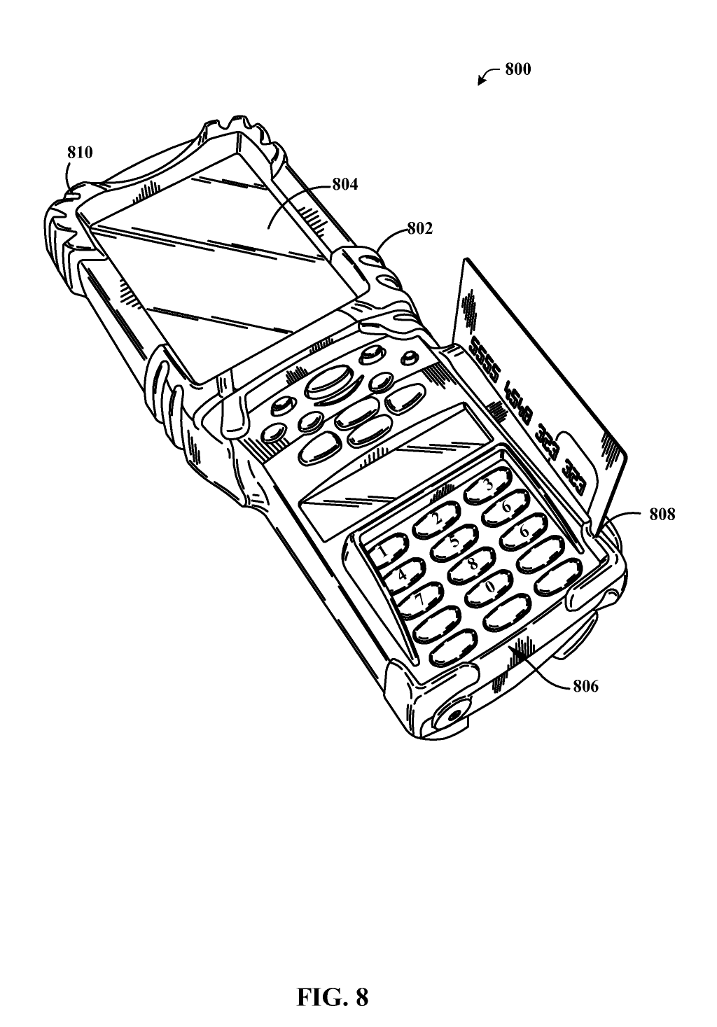

FIG. 8 is provided to assist in understanding and to provide context to an embodiment of the innovation. Specifically, FIG. 8 illustrates an example of a handheld terminal 800 (e.g., mobile device, access terminal, etc.) operative to execute the systems and/or methods disclosed herein. It is to be understood that the handheld terminal shown and described is merely exemplary and other devices can be utilized in accordance with the subject disclosure.

The handheld terminal 800 can include a housing 802, which can be constructed from a high strength plastic, metal, or any other suitable material. The handheld terminal 800 can also include a display 804. As is conventional, the display 804 functions to display data or other information relating to ordinary operation of the handheld terminal 800 and/or mobile companion (not shown). For example, software operating on the handheld terminal 800 and/or mobile companion can provide for the display of various information requested by the user.

Additionally, the display 804 can display a variety of functions that are executable by the handheld terminal 800 and/or one or more mobile companions. The display 804 can provide for graphics based alphanumerical information such as, for example, the price of an item requested by the user. The display 804 can also provide for the display of graphics such as icons representative of particular menu items, for example. The display 804 can also be a touch screen, which can employ capacitive, resistive touch, infrared, surface acoustic wave, or grounded acoustic wave technology.

The handheld terminal 800 can further include user input keys 806 for allowing a user to input information and/or operational commands The user input keys 806 can include a full alphanumeric keypad, function keys, enter keys, etc. The handheld terminal 800 can also include a magnetic strip reader 808 or other data capture mechanism (not shown). An electronic signature apparatus can also be employed in connection with the magnetic strip reader or a telecheck system.

The handheld terminal 800 can also include a window 810 in which a bar code reader/bar coding imager is able to read a bar code label, or the like, presented to the handheld terminal 800. The handheld terminal 800 can include a light emitting diode (LED) (not shown) that is illuminated to reflect whether the bar code has been properly or improperly read. Alternatively, or additionally, a sound can be emitted from a speaker (not shown) to alert the user that the bar code has been successfully imaged and decoded. The handheld terminal 800 can also include an antenna (not shown) for wireless communication with a radio frequency (RF) access point; and an infrared (IR) transceiver (not shown) for communication with an IR access point.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

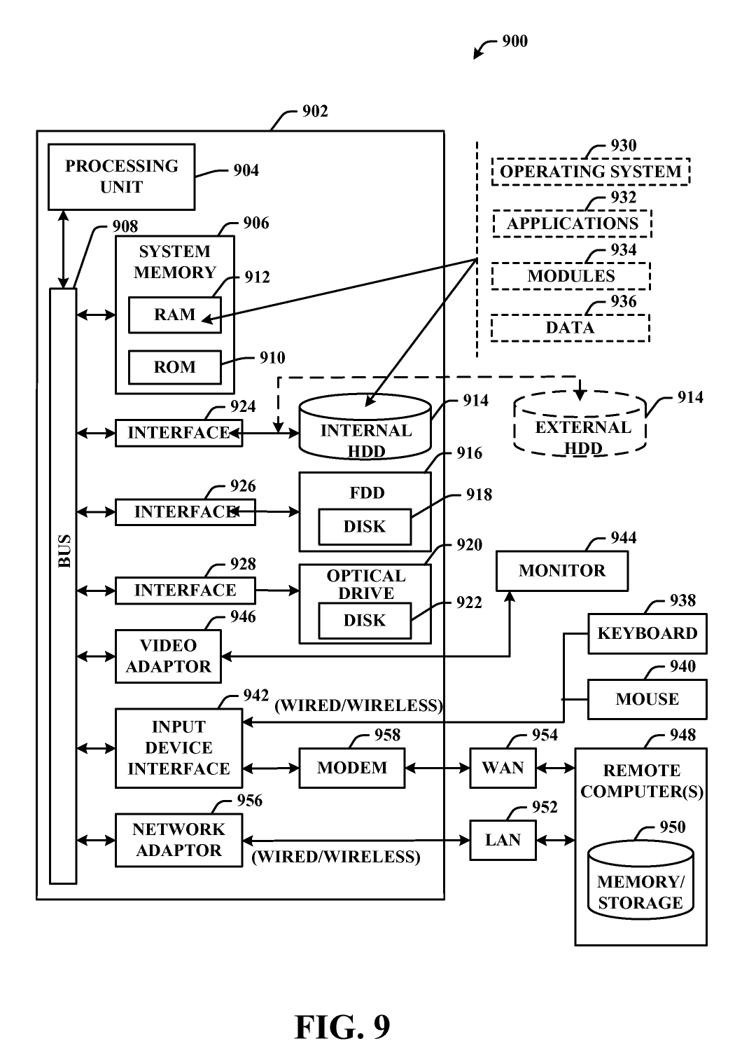

Referring now to FIG. 9, there is illustrated a block diagram of a computer operable to execute the disclosed architecture. In order to provide additional context for various aspects of the subject invention, FIG. 9 and the following discussion are intended to provide a brief, general description of a suitable computing environment 900 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, there is illustrated an exemplary environment 900 for implementing various aspects of the invention that includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices, and companies, and facilitate enterprise-wide computer networks, such as intranets, all of which may connect to a global communication network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

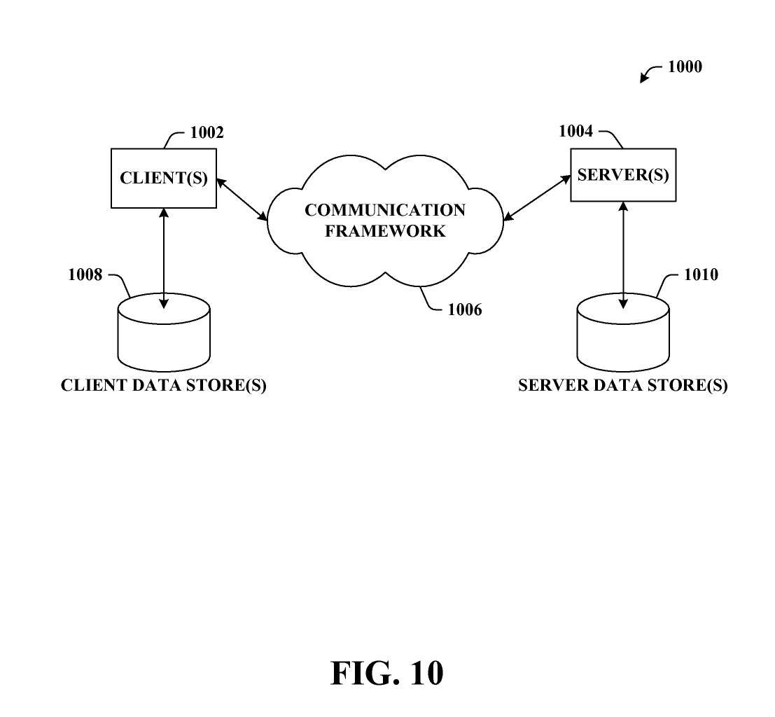

Referring now to FIG. 10, there is illustrated a schematic block diagram of an exemplary computing environment 1000 in accordance with the subject invention. The system 1000 includes one or more client(s) 1002. The client(s) 1002 can be hardware and/or software (e.g., threads, processes, computing devices). The client(s) 1002 can house cookie(s) and/or associated contextual information by employing the invention, for example.

The system 1000 also includes one or more server(s) 1004. The server(s) 1004 can also be hardware and/or software (e.g., threads, processes, computing devices). The servers 1004 can house threads to perform transformations by employing the invention, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile device, comprising:
an inbox that collects text messages from at least one mobile device; and
an agent that detects an identifier on at least one text message in the inbox, wherein the identifier designates the text message as a configuration file, and the agent processes the configuration file text message.

2. The mobile device of claim 1, wherein the agent transmits a request to a server based at least in part on the configuration file text message.

3. The mobile device of claim 2, wherein the request is sent to a server having an internet protocol address based on data contained in the configuration file text message.

4. The mobile device of claim 3, wherein the request includes a file name and path based on data contained in the configuration file text message.

5. The mobile device of claim 4, wherein the agent obtains a data packet from the server in response to the request.

6. The mobile device of claim 5, wherein the data packet is at least one of an operating system update or firmware update.

7. The mobile device of claim 5, wherein the agent at least one of obtains the data packet from the server, or transmits the request to the server via at least one of general packet radio service, CDMA, Bluetooth, wired local area network, wireless local area network, 3G, 4G, adhoc network, or Wi-Fi.

8. The method of claim 1, wherein the agent is at least one of an application, process, or thread executing on the mobile device.

9. The mobile device of claim 1, wherein the server is at least one of a desktop computer, web server, or a laptop computer.

10. A method facilitating mobile device updates, comprising:
receiving at least one text message having an indicator, wherein the indicator identifies the text message as containing a configuration file; and
processing the configuration file contained in the text message, including determining at least one of a server internet protocol address, a file name, or a file path from the configuration file.

11. The method of claim 10, further comprising transmitting a request to the server internet protocol address contained in the configuration file.

12. The method of claim 11, wherein the request queries the server for the file specified in the configuration file.

13. The method of claim 11, further comprising receiving a data packet from the server in response to the request, wherein the data packet is the file specified in the configuration file.

14. The method of claim 13, wherein the data packet is at least one of an operating system upgrade or firmware upgrade.

15. The method of claim 13, wherein at least one of the data packet is received or the request is sent via at least one of general packet radio service, CDMA, Bluetooth, wired local area network, wireless local area network, 3G, 4G, adhoc network, or Wi-Fi.

16. A system for mobile device updates, comprising:
means for receiving at least one text message having an identifier, wherein the identifier indicates that the text message contains a configuration file;
means for processing the configuration file contained in the text message, including determining a server internet protocol address, a file name, and a file path from the configuration file;
means for transmitting a request to the server internet protocol address contained in the configuration file;
means for receiving a data packet from the server in response to the request, wherein the data packet is the file specified in the configuration file; and
means for updating the mobile device by installing the file contained in the data packet.

17. The system of claim 16, wherein at least one of the data packet is received or the request is transmitted via at least one of general packet radio service, CDMA, Bluetooth, wired local area network, wireless local area network, 3G, 4G, adhoc network, or Wi-Fi.

18. The system of claim 16, wherein the data packet is at least one of a newer version of an operating system or firmware.

19. A system for updating mobile devices, comprising:
a first mobile device that transmits a text message to at least one additional mobile device, wherein the text message includes an identifier that indicates the text message includes a configuration file;
a second mobile device that receives the text message, detects the identifier, processes the configuration file, and determines a server internet protocol address, a file name, and file path based on data contained in the configuration file, and sends a request to the internet protocol address for the file having the specified file name and path; and
a server residing at the internet protocol address that transmits a data packet to the second mobile device in response to the request, wherein the data packet includes at least one of a operating system or firmware update.

20. The system of claim 19, wherein the second mobile device installs the operating system or firmware update.
